(19) United States
(12) Patent Application Publication
(10) Pub. No.: US 2020/0214794 A1
(43) Pub. Date: Jul. 9, 2020

(54) Teeth-Cleaning Device

(71) Applicant: Henry Hu, West Covina, CA (US)

(72) Inventor: Henry Hu, West Covina, CA (US)

(21) Appl. No.: 16/366,257

(22) Filed: Mar. 27, 2019

(30) Foreign Application Priority Data
Jan. 8, 2019 (CN) 201910017208.7

(51) Int. Cl. A61C 1/00; A61C 17/02

(52) U.S. Cl. CPC A61C 1/0092; A61C 17/0202

(57) ABSTRACT

Present invention teaches a portable teeth-cleaning device where a flexible water tank is stored inside the main body of the device; when water is being sent into the flexible water tank, getting it ready for use, the tank will expand in volume and come out of the main body. A pump is used to perform the water intake function and the water squirt-out function, via guide channels, with controlling means to control the mechanism of either 3 valves or 2 switch valves to effectuate the intended functions.

### PRIORITY CLAIM

Present application claims the foreign priority of an application filed in China dated Jan. 08, 2019, application number 201910017208.7. A Request to Retrieve Electronic Priority Application (SB/38) is attached along with this application.

### FIELD AND BACKGROUND OF THE INVENTION

Present invention relates to water-based cleaning devices that fit modern day's dental hygiene, which also contribute to the dental cosmetic purposes.

The use of water-based teeth-cleaning has become popular as an after-meal device, instead of a one-time-before-bed device. Commonly available water-based cleaning devices, such as the popular water flosser products, are usually bulky and not for personal or portable use.

The commonly available water-based cleaning devices generally rely on a tube to suction water from a tank, and squeeze out a water stream to clean teeth and teeth gaps. The time needed is at least 2 minutes, to run through the whole cycle. In addition, when a user's hand gesture moves around too much during use, the water suctioning tube can get easily detached from the water bowl, and resulting in air being pumped to the squirt-out mouth and reducing the effectiveness of water cleaning.

To overcome these problems, present invention uses a water tank that store the water within the main body of the device, and ensure that, during cleaning cycle, the supply of water will not be disrupted even if a user's hand gesture moves more than normal, and will not result in air gaps or bubbles being pumped out to the squirt-out mouth.

The smaller size of the device of present invention also makes the portable and personal use more convenient.

### SUMMARY OF THE INVENTION

The invention relates to a compact size, portable and easy to use teeth-cleaning device, containing, among others, a main body, a flexible water tank, a pump, an inject port, and a squirt mouth with a squirt port.

The flexible water tank is connected to the main body and further consists of a tank bag and a pressure-limiting bag. The flexible water tank resides inside the main body when not in use and expands in volume and protrudes out of the main body when filling in water to the extent restricted by the pressure-limiting bag.

Preferably, a low 5-10 PSI pressure will be sufficient to inflate the flexible water tank during the water intake function.

A pump resides within the main body to perform water intake function from the inject port to the flexible water tank and to perform water squirt-out function from the flexible water tank.

A guide channel is implemented by a first guide tube and second guide tube, creating two different flow paths: water intake path (solid lines) and water squirt-out path (dotted lines).

The first guide tube connects the pump and the flexible water tank for water intake purpose; and said second guide tube connects the pump and the flexible water tank for water squirt-out purpose.

Two different controlling means to effectuate the water flow mechanism for the intended functions are disclosed: either 3 valves or 2 switch valves.

First control means to control the water intake and the water squirt-out functions is embodied by using 3 valves.

Another embodiment of the control means uses two switch valves.

When the device of present application is not in use, there is no water inside the flexible water tank, the tank is hidden inside the main body. When the device is being used, water will first be sent into the flexible water tank, causing the volume to expand and pop out from the main body.

The squirt port can be detached from the main body for easy storage and for cleaning purpose.

### DESCRIPTION OF THE DRAWINGS

The accompanying drawings, which are incorporated in and constitute a part of this specification, illustrate and exemplify the preferred embodiments of the invention. Together with the description, serve to explain the principles of the invention.

A brief description of the drawings is as follows:

FIG. 1 is the perspective view of present invention with the flexible water tank filled with water and expanding outside of the main body of the device.

FIG. 2 is the perspective view of the present invention when there is no water in the device. As such, the water tank is collapsed and stored inside the main body, invisible from the outside.

FIG. 3 shows the main structural view of the present invention.

FIG. 4 shows the teeth-cleaning device of present invention using the first controlling mechanism of 3 valves.

FIG. 5 shows the teeth-cleaning device of present invention using the second controlling mechanism of 2 switch valves.

### DETAILED DESCRIPTION OF THE PREFERRED EMBODIMENT

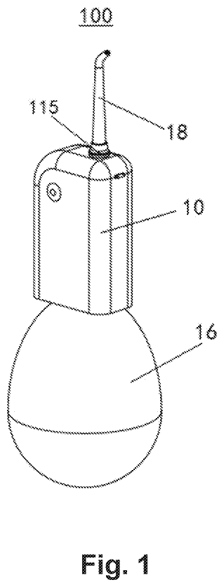

As shown in FIG. 1, the teeth-cleaning device 100 of present invention comprised of a main body 10, a flexible water tank 16, a pump 11, an inject port 12, and a squirt mouth 18 at a distal end of a squirt port 115. The squirt mouth 18 can be made to be detachable from the main body 10.

The flexible water tank 16 is connected to the main body 10 and further consists of a tank bag 164 and a pressure-limiting bag 167, whereby the flexible water tank 10 resides inside the main body 10 when not in use and expands in volume and protrudes out of the main body 10 when filling in water to the extent restricted by the pressure-limiting bag 167.

The tank bag 164 can be made from expandable and flexible materials, such as rubber, silicon gel, or any other suitable materials. The pressure-limiting bag 167 serves to place a safety guard as to the maximum water, and thus pressure, that can be placed into the tank bag 164.

Preferably, a low 5-10 PSI pressure will be sufficient to inflate the flexible water tank 16 during the water intake function.

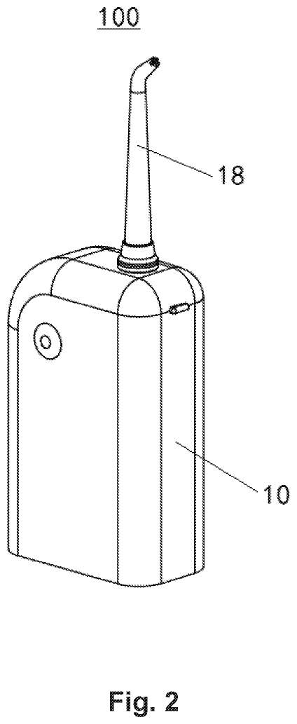

FIG. 1 shows the flexible water tank 16 residing inside the main body 10 and FIG. 2 shows the water tank 16 protruding out of the main body 10.

The use of the flexible water tank 16, instead of the commonly found fixed water tank with a suctioning tube connecting out, will help to prevent disruption of water squirting flow even if a user's hand gesture moves more than normal, and will not result in air gaps or bubbles being pumped out to the squirt mouth 18.

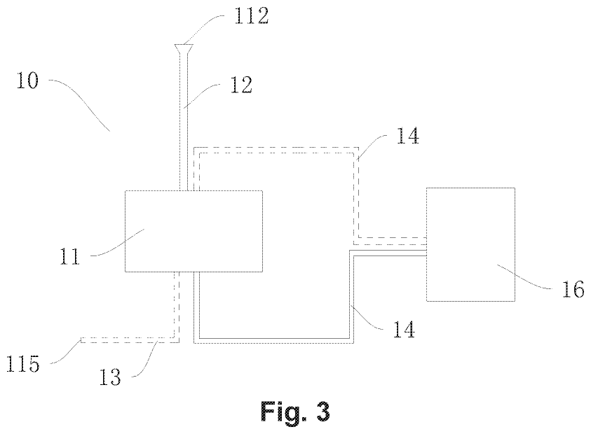

The main body 10 further contains an inject port 112 and a squirt port 115. The main body 10 further contains an intake channel 12 leading to the inject port 112. The main body 10 further contains a squirt channel 13 leading to the squirt port 115. Reference FIG. 3.

A pump 11 resides within the main body 10 to perform water intake function by sending water from the inject port 112 to the flexible water tank 16 and to perform water squirt-out function by sending water from the flexible water tank 16 to the squirt port 115.

FIG. 3 shows a guide channel 14 in solid lines and dotted lines, as a distinction between guiding the water in (solid lines) and squirting water out (dotted lines).

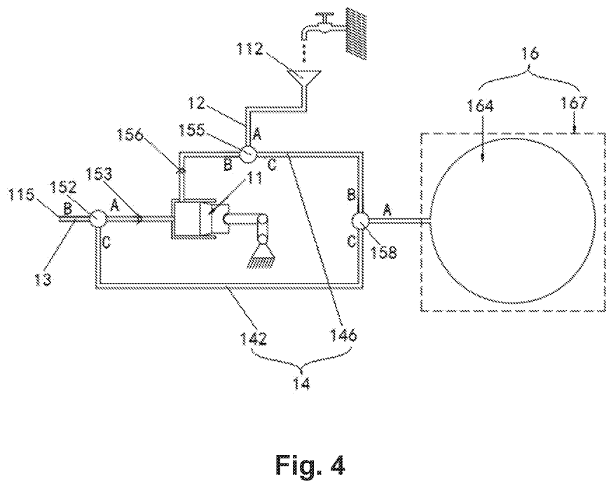

The implementation of the guide channel 14, shown in FIG. 3 and FIG. 4, is made up of a first guide tube 142 and a second guide tube 146, wherein said first guide tube 142 connects the pump 11 and the flexible water tank 16 for water intake purpose; and said second guide tube 146 connects the pump 11 and the flexible water tank 16 for water squirt-out purpose.

A control means to control the water intake and the water squirt-out functions is embodied by using 3 valves: first valve 152, second valve 155 and third valve 158. All the 3 valves are 2P3W (short for 2-Position-3-Way) valves that have two control positions for making 3-way connections. Each of the 3 valves uses A/B/C to note the flow-way, as shown in FIG. 4.

As shown in FIG. 4, squirt channel 13 connects pump 11 and squirt port 115. A first valve 152 is set on squirt channel 13. Intake channel 12 connect pump 11 and inject port 112. A second valve 155 is set on intake channel 12. A third valve is set on a point where first guide tube 142 and second guide tube 146 merge together for connecting to the flexible water tank 16. A first end of first guide tube 142 connects to squirt channel 13 via the first valve 152, with the other end of first guide tube 142 connects to the flexible water tank 16. This is the “water in” flow, shown as solid lines in FIG. 3.

A first end of second guide tube 146 connects to the intake channel 12 via the second valve 155, with the other end of second guide tube 146 connects to the flexible water tank 16. Along with a part of intake channel connected to the pump 11 and through the squirt channel 13, this forms the “water out” flow, shown as dotted lines in FIG. 3.

A first end of a third valve 158 connects to the flexible water tank 16 with the other end connecting to first guide tube 142 and second guide tube 146.

As such, by controlling the positions of the 3 2P3W valves, the water will flow in the designated way as desired, depending on the function intended: water intake or water squirt-out.

To perform water intake function, the first valve 152 will be set to connect A and B ways with respect to the first valve 152, the second valve 155 will be set to connect A and B ways with respect to the second valve 155, and the third valve 158 will be set to connect A and C ways with respect to the third valve 158. As such, water will come in from an external source through inject port 112, flowing through the second valve 155 A-B and into pump 11, which provides the pumping pressure to send the water through the first valve 152 A-C and via the third valve C-A to finally reach the flexible water tank 16.

The valves and the A/B/C ways within each valve, for the water flow control, are shown in FIG. 4.

To perform water squirt-out function, the first valve 152 will be set to connect A and B ways with respect to the first valve 152, the second valve 155 will be set to connect B and C ways with respect to the second valve 155, and the third valve 158 will be set to connect A and B ways with respect to the third valve 158. As such, water will be sent out from the flexible water tank 16, flowing through the third valve 158 A-B and the second valve 155 C-B, into the pump 11, which provides the pumping pressure to send water through the first valve 152 A-B and then to squirt out from the squirt channel 13.

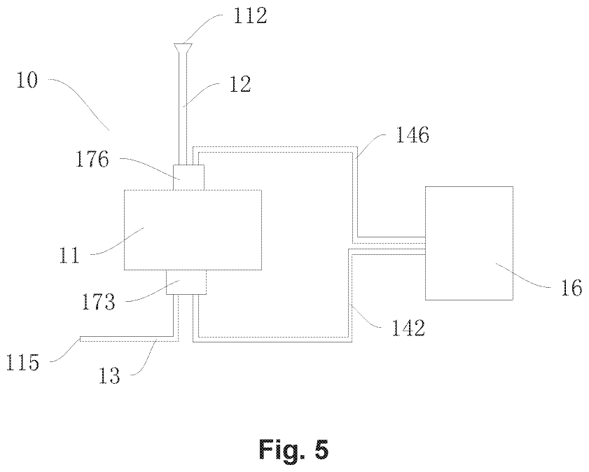

Another embodiment of the control means uses two switch valves: first switch valve 173 and second switch valve 176, as shown in FIG. 5.

In this embodiment, first guide tube 142 is used for water intake, and the second guide tube 146 is used for water squirt-out.

The pump 11 has a water-in port and a water-out port. The first switch valve 173 is located at the water-out port of pump 11. The second switch valve 176 is located at the water-in port.

The first switch valve 173 has a first out-port and a second out-port, and an in-port

The second switch valve 176 has a first in-port and a second in-port, and an out-port.

One end of the squirt channel 13 is connected to the first out-port of the first switch valve 173, with the other end connecting to squirt port 115.

One end of the intake channel 12 is connected to the inject port 112, with the other end connecting to the first in-port of the second switch valve 176.

One end of the first guide tube 142 is connected to the second out-port of the first switch valve 173, with the other end connecting to the flexible water tank 16.

One end of the second guide tube 146 is connected to the flexible water tank 16, with the other end connecting to the second in-port of second switch valve 176.

As such, intake channel 12 and first guide tube 142 form a water intake path (said path was shown as solid lines in FIG. 3); squirt channel 13 and second guide tube 146 form a water squirt-out path (said path was shown as dotted lines in FIG. 3).

In this embodiment, the flexible water tank has a water intake port and water exit port, eliminating the need for one control valve, reducing the parts used in the teeth-cleaning device of present application.

When the device 100 of present application is not in use, there is no water inside the flexible water tank 16, the tank 16 is hidden inside the main body 10. When the device 100 is being used, water will first be sent into the flexible water tank 16, causing the volume to expand and pop out from the main body 10 as shown in FIG. 1.

The 3 valves 152, 155 and 158, the pump 11 and the 2 switch valves are off-the-shelf electrical components, with appropriate commercial grade PLC controllers. Such use is known in the relevant art and requires no special disclosure herein.

The squirt port 115 can be detached from the main body 10 for storage and for cleaning purpose.

1. A teeth-cleaning device, comprising:
a main body containing an inject port and a squirt port;
an intake channel connected to said main body;
a squirt channel connected to said main body;
a flexible water tank connected to the main body, said flexible water tank further consists of a tank bag and a pressure-limiting bag, whereby the flexible water tank resides inside the main body when not in use and expands in volume when filling in water to the extent restricted by the pressure-limiting bag;
a pump within the main body to perform the water intake function by sending water from the inject port to the flexible water tank and to perform the water squirt-out function by sending water from the flexible water tank to the squirt port;
a guide channel made up of a first guide tube and a second guide tube, wherein said first guide tube connects the pump and the flexible water tank for water intake purpose, and said second guide tube connects the pump and the flexible water tank for water squirt-out purpose; and
means for controlling water intake from said inject port on the main body and for controlling water squirt-out via said squirt port on the main body, wherein said squirt port further having a detachable squirt mouth at a distal end.

2. The device claim 1, wherein the means for controlling the water intake and water squirt-out consists of a first valve being set on the squirt channel, the second valve being set on the intake channel, and the third valve being set on a point where first guide tube and second guide tube merge together for connecting to the flexible water tank.

3. The device of claim 1, wherein the means of controlling the water intake and water squirt-out consists of a first switch valve located at a water-out port of the pump and a second switch valve located at a water-in port of the pump;
wherein the first switch valve has a first out-port and a second out-port, and an in-port, the second switch valve has a first in-port and a second in-port, and an out-port;
wherein one end of the squirt channel is connected to the first out-port of the first switch valve, with the other end connecting to squirt port; one end of the intake channel is connected to the inject port, with the other end connecting to the first in-port of the second switch valve; one end of the first guide tube is connected to the second out-port of the first switch valve, with the other end connecting to the flexible water tank, and
wherein the flexible water tank has a water intake port and a water exit port.
